(19) United States
(12) Patent Application Publication
(10) Pub. No.: US 2002/0185494 A1
(43) Pub. Date: Dec. 12, 2002

(54) Container with integral, flexible spout

(76) Inventor: Charles E. Phillips JR., Signal Mountain, TN (US)

Correspondence Address: J. W. Gipple, GIPPLE & HALE, P.O. Box 40513, Washington, DC, 20016, US

(21) Appl. No.: 09/876,597

(22) Filed: Jun. 8, 2001

(51) Int. Cl. B65B 3/00; B67C 3/00; B65D 47/02; B65D 49/00

(52) U.S. Cl. 220/86.2

(57) ABSTRACT

A container for dispensable liquid is provided with an integral, pleated spout portion that can be extended to form a flexible spout to accommodate awkward angles needed to access the engine aperture.

### FIELD OF THE INVENTION

The present invention is a container for dispensable liquid, said container having flexible spout to accommodate awkward circumstances to accessing the aperture in which to dispense the liquid.

### BACKGROUND OF THE INVENTION

The internal combustion engines of automobiles, tractors, motorboats, and lawn motors, among others, require motor oil. Such engines have an aperture covered with a removable cap which usually includes a dip stick. Removing the cap provides access to the interior of the engine, particularly the crank case. Motor oil and other appropriate additives can be poured into the opening and flow, by gravity, down into the crankcase.

Internal combustion engines must also have numerous attachments for ignition, combustion, cooling, etc. As a result, access to the aperture of the engine is frequently obstructed such attachments to the engine, as well as by the housing of the engine. So getting motor oil into the engine is often a challenge.

In commercial garages and service stations, motor oil is generally dispensed from bulk containers into an oilcan, which has an extendable often flexible spout. But most ordinary households and private car owners do not have such oilcans and do not buy motor oil in fifty gallon barrels. They buy motor oil in quart containers. Such quart containers used to be mostly metal cans. A metal spout was adapted that had an opener to pierce the top of the container and temporarily secure it in that position. The metal spout was not flexible, but about six inches long and slightly bent. If one was agile, one could get the metal spout into the engine's aperture without pouring much of the oil over adjacent portions of the engine. But, since the spout connection to the container was not very tight, more oil leaked onto the exterior of the engine block. This not only wasted oil, but when the engine was running and hot, the wasted oil began to burn off creating smoke and fumes and the possible danger of fire.

In recent years, motor oil is sold mostly in quart plastic bottles that have necks of appropriate size to insert into the aperture of an engine, and stay there until its content has drained into the crankcase. But, like the metal can with metal spout, the plastic bottle tends to spill much of its content as the user, attempts to manipulate its neck into the open aperture of the engine.

Accordingly, there is a need for a container of motor oil or such, that has an integral, extendable and flexible spout to facilitate pouring its content into an engine with minimal spillage.

### DESCRIPTION OF THE PRIOR ART

The prior art considered relevant to the present invention is the conventional oilcan. Applicant is not presently aware of any prior art that teaches the specific adaptation of an extendable, flexible spout integral to a container for dispensing its liquid content.

### SUMMARY OF THE INVENTION

The present invention is directed to a container for motor oil or other such additive to be poured into the aperture of an engine or any other aperture, the access to which may be impeded. Integral to the container is a pleated, extendable and flexible spout and a removable cap. The container with extended flexible spout allows access around impediments to the aperture for which it is intended. After using, the flexible spout can be collapsed, the cap put back on, and stored for later use.

The present invention benefits not only the user, by not wasting motor oil and other such costly additives, but also benefits the environment by not wasting the oil and from the fact that the plastic container, spout and cap can be recycled.

### BRIEF DESCRIPTION OF THE DRAWINGS

FIG. 1 is a front elevation view of the container of the invention.

FIG. 2 is a front elevation view of the container with it's integral spout extended and cap lifted.

FIGS. 3 and 4 are front elevation views of the container with the spout flexed into two different configurations.

### DETAILED DESCRIPTION OF THE INVENTION

The present invention is directed to a container for motor oil or other such additive to be poured into the aperture of an engine or any other aperture, the access to which may be impeded. Integral to the container is a pleated, extendable, flexible spout and a removable cap covering the upper end of the spout. When the cap is removed, and the spout extended it can be flexed into all various configurations required to circumvent impediments and adapt to awkward angles.

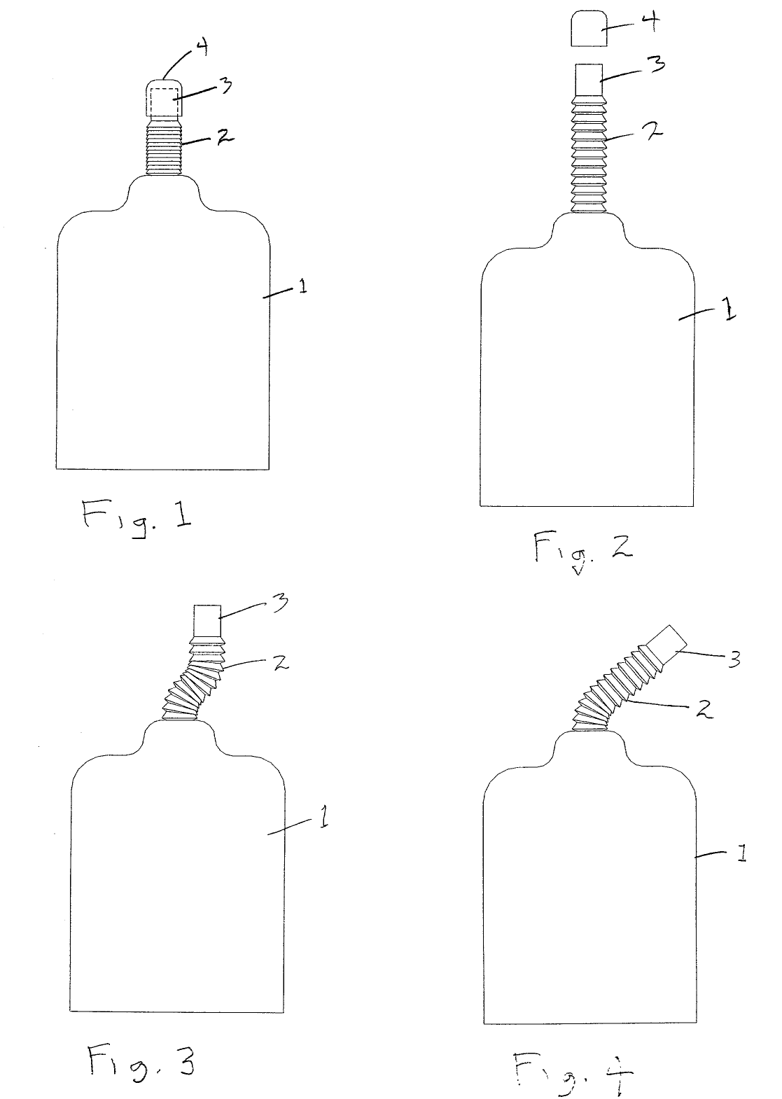

Directing attention to the drawings, FIG. 1 illustrates the container 1, having on its upper end an integral, pleated, extendable spout 2. On the upper end of spout 2, is a rigid spout terminus 3, which is covered by a removable cap 4. The container 1, spout 2, spout terminus 3 and cap 4 are all formed of plastic.

As shown in FIG. 2, the cap 4 can be removed and the spout 2 extended upwardly.

When extended, the pleats of spout 2, being made of relatively thin and flexible plastic allow the spout 2 to be twisted and turned into an almost endless variety of positions. Two such positions are shown in FIGS. 3 and 4.

The spout terminus 3 is of plastic thicker than that of the pleated spout 2, and has no pleats. Therefore, it is relatively rigid which is desirable since the spout terminus 3 is the portion of the spout which is extended into the aperture of the engine.

Other modifications and alternatives to the herein described container with integral, extendable, flexible spout will be apparent to those of ordinary skill in this art and are considered to fall within the scope of the claims defining the invention.

What is claimed is:

1. A container for dispensable liquid comprising:
a body portion for holding the liquid
a spout portion on the upper end of said body portion and integral therewith, said spout portion being comprised of pleated flexible material

2. The container of claim 1, which includes a removable cap to cover the upper end of the said spout portion.

3. The container of claim 1, which includes a rigid terminus on the upper end of the said spout portion.

4. The container of claim 1, in which the body portion and spout portion are made of the same recyclable plastic material.

5. The container of claim 2, in which the body portion, spout portion and removable cap are made of the same recyclable plastic material.

6. The container of claim 3, in which the body portion, spout portion and rigid terminus are made of the same recyclable plastic material.
